(19) United States
(12) Patent Application Publication
(10) Pub. No.: US 2015/0321850 A1
(43) Pub. Date: Nov. 12, 2015

(54) GAS STORAGE REFILL AND DEWATERING

(71) Applicant: Ronald STRYBOS, Kountze, TX (US)

(72) Inventor: Ronald STRYBOS, Kountze, TX (US)

(73) Assignee: AIR LIQUIDE LARGE INDUSTRIES U.S. LP, Houston, TX (US)

(21) Appl. No.: 14/272,684

(22) Filed: May 8, 2014

(51) Int. Cl. B65G 5/00; F17C 5/06

(52) U.S. Cl. CPC B65G 5/005; F17C 5/06; F17C 2221/012; F17C 2223/033; F17C 2225/033; F17C 2227/00

(57) ABSTRACT

A method of maintaining pressure in an underground storage volume during transient operation is presented. Including storing a first compressible fluid, determining a safe minimum operating pressure (Pₘᵢₙ), and a safe maximum operating pressure (Pₘₐₓ), measuring the pressure (P_{act}), removing or introducing the first compressible fluid, and concurrently, introducing or removing an incompressible wherein the flow rate of the incompressible fluid is controlled such that Pₘᵢₙ<P_{act}<Pₘₐₓ. The method may include injecting a second compressible fluid into an incompressible fluid within the underground storage volume, thereby producing a gas lift fluid.

### BACKGROUND

Hydrogen is commonly supplied to customers that are connected to a supplier's hydrogen pipeline system. Typically, the hydrogen is manufactured by steam methane reforming in which a hydrocarbon such as methane and steam are reacted at high temperature in order to produce a synthesis gas containing hydrogen and carbon monoxide. Hydrogen may then be separated from the synthesis gas to produce a hydrogen product stream that is introduced into the pipeline system for distribution to customers that are connected to the pipeline system. Alternatively, hydrogen produced from the partial oxidation of a hydrocarbon can be recovered from a hydrogen rich stream.

Typically, hydrogen is supplied to customers under agreements that require availability and reliability for the steam methane reformer or hydrogen recovery plant. When a steam methane reformer is taken off-line for unplanned or extended maintenance, the result could be a violation of such agreements. Additionally, there are instances in which customer demand can exceed hydrogen production capacity of existing plants in the short term. Having a storage facility to supply back-up hydrogen to the pipeline supply is therefore desirable in connection with hydrogen pipeline operations.

Considering that hydrogen production plants on average have production capacities that are roughly 50 million standard cubic feet per day, a storage facility for hydrogen that would allow a plant to be taken off-line, to be effective, would need to have storage capacity in the order of 1 billion standard cubic feet or greater.

In order to provide this large storage capacity, high pressure gases, such as but not limited to nitrogen, air, carbon dioxide, hydrogen, helium, and argon, are stored in caverns, whether leached in salt formations or created by hard rock mining. A minimum volume of gas is stored in the cavern to provide adequate pressure to maintain the integrity of the cavern and prevent the cavern roof from collapsing and to keep the cavern walls from moving inward. This minimum volume of gas is called the pad gas or base gas. The amount of gas stored in addition to the pad gas or base gas volume is called the working gas or working inventory. For the purpose of this invention, the definition of high pressure is defined as a pressure at or above 10 atm.

### SUMMARY

A method of maintaining pressure in an underground storage volume during transient operation is presented. The method includes storing a first compressible fluid in an underground storage volume, determining a safe minimum operating pressure (Pₘᵢₙ), and a safe maximum operating pressure (Pₘₐₓ) for said underground storage volume, measuring the pressure (P_{act}), of said underground storage volume, removing at least a portion of said first compressible fluid from said underground storage volume, and concurrently, introducing an incompressible fluid into said underground storage volume, wherein the flow rate of said incompressible fluid is controlled such that Pₘᵢₙ<P_{act}<Pₘₐₓ.

The underground storage volume may be an underground salt cavern. The first compressible fluid may be selected from the group consisting of nitrogen, air, carbon dioxide, hydrogen, helium, and argon. The compressible fluid may be selected from the group consisting of brine, water, or water slurry.

The method may also include a length of casing, permanently cemented into the surrounding rock formations, with a final cemented casing shoe defining the practical endpoint at an approximate depth (D_{casing}), and determining a minimum pressure gradient (Gₘᵢₙ) for said underground storage volume, wherein Pₘᵢₙ>D_{casing}×Gₘᵢₙ. The method may be such that 0.2 psi/ft of depth<Gₘᵢₙ<0.4 psi/ft of depth. The method may be such that 0.3 psi/ft of depth<Gₘᵢₙ<0.35 psi/ft of depth.

The method may also include a length of casing, permanently cemented into the surrounding rock formations, with a final cemented casing shoe defining the practical endpoint at an approximate depth (D_{casing}), and determining a maximum pressure gradient (Gₘₐₓ) for said underground storage volume, wherein Pₘₐₓ<D_{casing}×Gₘₐₓ.

The method may be such that 0.7 psi/ft of depth<Gₘᵢₙ<0.9 psi/ft of depth. The method may be such that 0.8 psi/ft of depth<Gₘᵢₙ<0.85 psi/ft of depth. The incompressible fluid may not exceed a predetermined maximum flow rate (Fₘₐₓ). The method may be such that Fₘₐₓ is 20 feet per second.

The method may include storing a first compressible fluid in an underground storage volume, determining a safe minimum operating pressure (Pₘᵢₙ), and a safe maximum operating pressure (Pₘₐₓ) for said underground storage volume, measuring the pressure (P_{act}), of said underground storage volume, introducing said first compressible fluid into said underground storage volume, and concurrently, removing an incompressible fluid from said underground storage volume, wherein the flow rate of said incompressible fluid is controlled such that Pₘᵢₙ<P_{act}<Pₘₐₓ.

The method may include injecting a second compressible fluid into an incompressible fluid within the underground storage volume, thereby producing a gas lift fluid, removing said gas lift fluid from said underground storage volume, introducing said gas lift fluid into a degassing system, thereby producing the incompressible fluid and the second compressible gas. The second compressible fluid may be selected from the group consisting of nitrogen, carbon dioxide, air, helium, or argon. The degassing system may be a degassing pond or a degassing tank.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates an embodiment of the current invention; and

FIG. 2 illustrates another embodiment of the current invention.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The safe operating pressure range for high pressure gas caverns is defined as the pressure between the minimum pressure and maximum pressure of the cavern. These pressure extremes are intended to prevent potential collapse or fracture of the cavern. The minimum operating pressure is a function of the depth of the last cemented pipe casing shoe and the minimum pressure gradient, which is determined for the evaluation of the strength of the salt or rock formation and is typically of a value of 0.3 psi to 0.35 psi per foot of depth. The maximum operating pressure is a function of the depth of the last cemented pipe casing shoe and the maximum pressure gradient typically defined by regulatory statute and is typically of a value of 0.8 psi to 0.85 psi per foot of depth. A maximum product pressure increase rate (PRateₘₐₓ) may be determined, wherein the maximum product pressure increase is controlled such that PRateₘₐₓ, <150 psig per day.

In one embodiment of the present invention, it is claimed that the addition or removal of liquid is controlled such that the operating pressure of the cavern is maintained above the minimum pressure and below the maximum pressure to maintain cavern integrity. The use of flow and pressure control valves, whether automatic or manual or in combination, on the liquid lines and the storage gas lines may be the primary control means to implement this method. The control of liquid flow and pressure and storage gas flow and pressure may be by operation of the valves so as to maintain the required pressure in the cavern to prevent cavern collapse or fracture.

The addition or removal of liquid may be controlled such that the velocity of the liquid re-entering the cavern is less than 20 ft/sec based on the calculation of the internal cross sectional area of the liquid piping and the flow rate of the liquid through the piping. Velocities in excess of 20 ft/sec may cause a natural frequency harmonic that can cause the failure of the liquid piping and could lead to an uncontrolled gas release.

The initial removal of liquid from the cavern may require the use of a gas lift to lighten the density of the liquid to assist in starting the liquid flow from the cavern. Since the first storage gas flow into the cavern may not displace the liquid, a gas lift, such as nitrogen, carbon dioxide, air, helium, or argon, is injected down the liquid piping, either by means of a coiled tubing, or other small diameter piping, such that the density of the liquid is decreased so that the compressed storage gas introduced into the cavern forces the liquid out of the cavern. The liquid and lift gas mixture is then piped to a degassing pond or tank. Liquid flow rate is maintained at a velocity less than 20 ft/sec as described above.

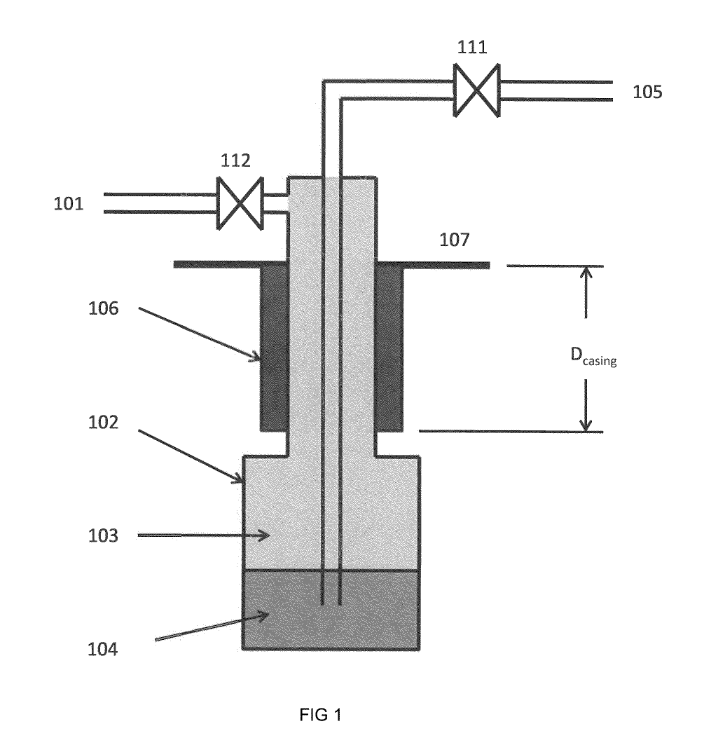

Turning to FIG. 1, compressible fluid 103 is stored in underground storage volume 102. Underground storage volume 102 may be a salt cavern, a depleted reservoir in an oil or gas field, an aquifer, or any system know to one skilled in the art. The underground storage volume 102 may have a first conduit 101, with flow and/or pressure control valve 112, for admitting or removing the compressible fluid 103. The underground storage volume 102 may contain an incompressible fluid 104. Incompressible fluid 104 may be water, water slurry, brine, diesel, or any appropriate fluid known to one skilled in the art. The underground storage volume 102 may have a second conduit 105, with flow and/or pressure control valve 111, for admitting or removing incompressible fluid 104.

As the underground storage volume may be at a considerable depth below grade 107, the nominally vertical portions of first conduit 101 and/or second conduit 105 may be anchored into the surrounding rock formations by means of a cemented casing 106. The depth of the casing from grade 106 to the limit of the cemented casing 106 is the depth of the casing D_{casing}.

A safe minimum operating pressure Pₘᵢₙ and a safe maximum operating pressure Pₘₐₓ are determined for the underground storage volume. A minimum pressure gradient Gₘᵢₙ may be such that 0.2 psi/ft of depth<Gₘᵢₙ<0.4 psi/ft of depth. Gₘᵢₙ may be such that 0.3 psi/ft of depth<Gₘᵢₙ<0.35 psi/ft of depth. The safe minimum operating pressure Pₘᵢₙ may be defined as Pₘᵢₙ>D_{casing}×Gₘᵢₙ.

A maximum pressure gradient Gₘₐₓ may be such that 0.7 psi/ft of depth<Gₘₐₓ<0.9 psi/ft of depth. Gₘₐₓ may be such that 0.8 psi/ft of depth<Gₘₐₓ<0.85 psi/ft of depth. The safe maximum operating pressure Pₘₐₓ may be defined as Pₘₐₓ<D_{casing}×Gₘₐₓ.

In one embodiment of the present invention, as compressible fluid 103 is extracted from the underground storage volume 102, the transient pressure condition may be controlled by the inlet flow rate of incompressible fluid 104, such that Pₘᵢₙ<P_{act}<Pₘₐₓ. The maximum flow rate of incompressible fluid 104 may not exceed a predetermined maximum flow rate (Fₘₐₓ). Fₘₐₓ may not exceed 20 feet per second.

In another embodiment of the present invention, as compressible fluid 103 is introduced into the underground storage volume 102, the transient pressure condition may be controlled by the extraction flow rate of incompressible fluid 104, such that Pₘᵢₙ<P_{act}<Pₘₐₓ The maximum flow rate of incompressible fluid 104 may not exceed a predetermined maximum flow rate (Fₘₐₓ). Fₘₐₓ may not exceed 20 feet per second.

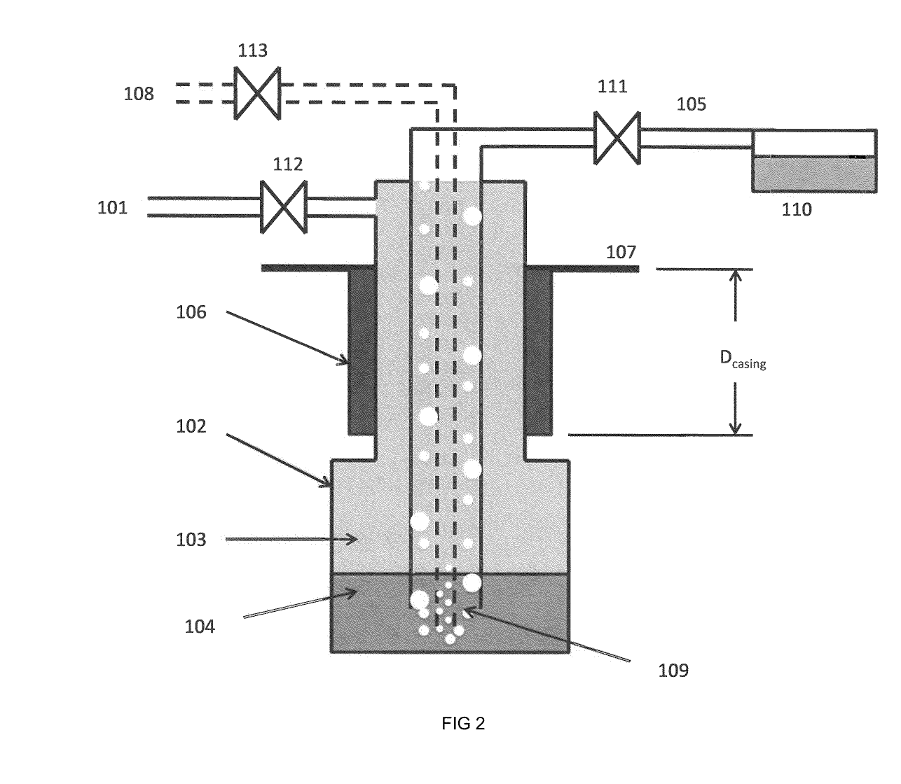

Turning to FIG. 2, in another embodiment of the present invention, a second compressible fluid 108, with flow and/or pressure control valve 113, may be introduced into incompressible fluid 104 within the storage volume, thereby producing a gas lift fluid 109. The gas lift fluid 109 is then removed from the underground storage volume 102 through conduit 105 and sent to degassing system 110. Degassing system 110 may be a degassing pond or a degassing tank.

1. A method of maintaining pressure in an underground storage volume during transient operation, comprising:
storing a first compressible fluid in an underground storage volume,
determining a safe minimum operating pressure (Pₘᵢₙ), and a safe maximum operating pressure (Pₘₐₓ) for said underground storage volume,
measuring the pressure (P_{act}), of said underground storage volume,
removing at least a portion of said first compressible fluid from said underground storage volume,
concurrently, introducing an incompressible fluid into said underground storage volume,
wherein the flow rate of said incompressible fluid is controlled such that Pₘᵢₙ<P_{act}<Pₘₐₓ.

2. The method of claim 1, wherein said underground storage volume is an underground salt cavern.

3. The method of claim 1, wherein said first compressible fluid is selected from the group consisting of nitrogen, air, carbon dioxide, hydrogen, helium, and argon.

4. The method of claim 3, wherein said first compressible fluid is hydrogen.

5. The method of claim 1, wherein said incompressible fluid is selected from the group consisting of brine, water, or water slurry.

6. The method of claim 1, further comprising;
a length of casing, permanently cemented into the surrounding rock formations, with a final cemented casing shoe defining the practical endpoint at an approximate depth (D_{casing}),
determining a minimum pressure gradient (Gₘᵢₙ) for said underground storage volume,
wherein Pₘᵢₙ>D_{casing}×Gₘᵢₙ.

7. The method of claim 6, wherein 0.2 psi/ft of depth<Gₘᵢₙ<0.4 psi/ft of depth.

8. The method of claim 7, wherein 0.3 psi/ft of depth<Gₘᵢₙ<0.35 psi/ft of depth.

9. The method of claim 1, further comprising;
a length of casing, permanently cemented into the surrounding rock formations, with a final cemented casing shoe defining the practical endpoint at an approximate depth (Dcasing),
determining a maximum pressure gradient (Gmax) for said underground storage volume,
wherein Pₘₐₓ<D_{casing}×Gₘₐₓ.

10. The method of claim 9, wherein 0.7 psi/ft of depth<Gₘᵢₙ<0.9 psi/ft of depth.

11. The method of claim 10, wherein 0.8 psi/ft of depth<Gₘᵢₙ<0.85 psi/ft of depth.

12. The method of claim 1, wherein said incompressible fluid does not exceed a predetermined maximum flow rate (Fₘₐₓ).

13. The method of claim 12, wherein Fₘₐₓ is 20 feet per second.

14. The method of claim 1, further comprising determining a maximum product pressure increase rate (PRateₘₐₓ) wherein the maximum product pressure increase is controlled such that PRateₘₐₓ, <150 psig per day.

15. A method of maintaining pressure in an underground storage volume during transient operation, comprising:
storing a first compressible fluid in an underground storage volume,
determining a safe minimum operating pressure (Pₘᵢₙ), and a safe maximum operating pressure (Pₘₐₓ) for said underground storage volume,
measuring the pressure (P_{act}), of said underground storage volume,
introducing said first compressible fluid into said underground storage volume,
concurrently, removing an incompressible fluid from said underground storage volume,
wherein the flow rate of said incompressible fluid is controlled such that Pₘᵢₙ<P_{act}<Pₘₐₓ.

16. The method of claim 15, wherein said underground storage volume is an underground salt cavern.

17. The method of claim 15, wherein said first compressible fluid is selected from the group consisting of nitrogen, air, carbon dioxide, hydrogen, helium, and argon.

18. The method of claim 17, wherein said first compressible fluid is hydrogen.

19. The method of claim 15, wherein said incompressible fluid is selected from the group consisting of brine, water, or water slurry.

20. The method of claim 15, further comprising;
a length of casing, permanently cemented into the surrounding rock formations, with a final cemented casing shoe defining the practical endpoint at an approximate depth (Dcasing),
determining a minimum pressure gradient (Gmin) for said underground storage volume,
wherein Pₘᵢₙ>D_{casing}×Gₘᵢₙ.

21. The method of claim 20, wherein 0.2 psi/ft of depth<Gₘᵢₙ<0.4 psi/ft of depth.

22. The method of claim 21, wherein 0.3 psi/ft of depth<Gₘᵢₙ<0.35 psi/ft of depth.

23. The method of claim 15, further comprising;
a length of casing, permanently cemented into the surrounding rock formations, with a final cemented casing shoe defining the practical endpoint at an approximate depth (Dcasing),
determining a maximum pressure gradient (Gmax) for said underground storage volume,
wherein Pₘₐₓ<D_{casing}×Gₘₐₓ.

24. The method of claim 23, wherein 0.7 psi/ft of depth<Gₘᵢₙ<0.9 psi/ft of depth.

25. The method of claim 24, wherein 0.8 psi/ft of depth<Gₘᵢₙ<0.85 psi/ft of depth.

26. The method of claim 15, wherein said incompressible fluid does not exceed a predetermined maximum flow rate (Fₘₐₓ).

27. The method of claim 26, wherein Fₘₐₓ is 20 feet per second.

28. The method of claim 15, further comprising;
injecting a second compressible fluid into an incompressible fluid within the underground storage volume, thereby producing a gas lift fluid,
removing said gas lift fluid from said underground storage volume,
introducing said gas lift fluid into a degassing system, thereby producing the incompressible fluid and the second compressible gas.

29. The method of claim 28, wherein said second compressible fluid is selected from the group consisting of nitrogen, carbon dioxide, air, helium, or argon.

30. The method of claim 29, wherein said second compressible fluid is air.

31. The method of claim 29, wherein said degassing system is a degassing pond.

32. The method of claim 29, wherein said degassing system is a degassing tank.

33. The method of claim 15, further comprising determining a maximum product pressure increase rate (PRateₘₐₓ) wherein the maximum product pressure increase is controlled such that PRateₘₐₓ, <150 psig per day.
